(19) United States
(12) Patent Application Publication
(10) Pub. No.: US 2002/0147904 A1
(43) Pub. Date: Oct. 10, 2002

(54) Electronic notarization on net system

(76) Inventor: Moritaka Nakamura, Kamakura-shi (JP)

Correspondence Address: Moritaka Nakamura, 4-8-33Kamakurayama, Kamakura-shi, Kanagawa, JP

(21) Appl. No.: 09/832,504

(22) Filed: Apr. 10, 2001

(51) Int. Cl. H04L 9/00

(52) U.S. Cl. 713/155

(57) ABSTRACT

A center site on net is prepared to record every data requested by client to be recorded by electronic database system and, when the center site recorded these data, the center site issues any receipt to the client.

When requested by the client site with this receipt, the center site notarizes its record, data, text, images, with issued receipt and recorded date.

### BACKGROUND OF THE INVENTION

The present invention relates to notarization on net system.

Here “notarization” means a social role, evidence making system.

Notary furnish as their business.

Notary, also called Notary Public, is the public official whose function in common-law countries is to authenticate contracts, deeds, and other documents by an appropriate certificate with a notarial seal.

Here “Authenticate” means, as an objective third party, person to witness the existence of above contracts, deeds, and other documents of the clients' on the witnessed date.

Image, when you want to claim to any company for their products for defect or to the government for not satisfactory their services!

You must contact with their agents and get any reply satisfactory or not satisfactory and you must want your these actions should be recorded and notarized for future

evidence.

Or sometimes you get any idea for business and want to contact with someone for any more steps, you should want your this idea can be notarized.

To our sorry, we have not such an easy accessing notarization system.

We have been difficult backing up our social action by notarization.

### SUMMARY OF THE INVENTION

It is therefore an object of the present invention, which has been devised to solve the problem above, to provide an efficient and easy access method for notarization.

This is a new notarization system on net.

A center site register, accept and store the record requested by the clients site and notarize the recorded data with the recorded date, when requested.

It works like the notary.

But it is very easy to access for every people from his site.

Clients can register and record everything they like, “text statement” or “drawings”, data possible for storing in the center site.

This enables for the registered clients providing evidence of existence of their record and recorded date.

Everyone as client can access center site for notarization every record or data, from his own site and the center site can store and certificate their record by database system.

This now becomes possible from the wonderful storing capacity of recent electronic database system.

This notarization system must help you.

### DETAILED DESCRIPTION OF THE INVENTION

For every people, when they want to act socially, to contact with other people or party, business company, commercial bank, hospital or government agents for any purpose, they must want to be notarized record of their contact and all its procedure.

For them, to be notarized means they can get an evidence of their record of contact, date and its procedure, with these people or agents.

The present invention, electronic notarization on net system is devised to solve this problem.

A center site on net is prepared to record every data requested by clients from their site.

A center site includes an open electronic record database.

This database stores record that are requested by the clients.

These records can be data by text statement or images that are possible for store in electronic database system.

Client can be every people who want to record his data from his site to this center site.

The center site is prepared to accept from client to record their data.

When the center site database system accept any clients' record, it issues any dated receipt, including recorded contents, recorded date with client's ID.

Once recorded, the center site is always prepared to accept clients' request for notarization, to certificate their record, contents and date.

The center site database must have a means for protecting stored records.

Now, everyone, as client can access center site for notarization every record or data, from his own site and center site can store and certificate their record by database system.

The wonderful storing capacity of recent electronic database system makes this notarization system possible, with not so much expense, throughout the world.

This notarization system must help you.

### BRIEF DESCRIPTION OF THE DRAWINGS

The Invention disclosed herein will be understood better with reference to the following drawings of which;

FIG. 1 is a view showing the relationships between the center site and clients site connected with the network, internet.

FIG. 2 is showing the center site with storing database, accepting and storing clients record and issuing its receipt.

It is also showing the safety guard system for the database.

FIG. 3 is showing a client who wants from his site to get certificate of his record asking with his receipt, issued by the center site on FIG. 2.

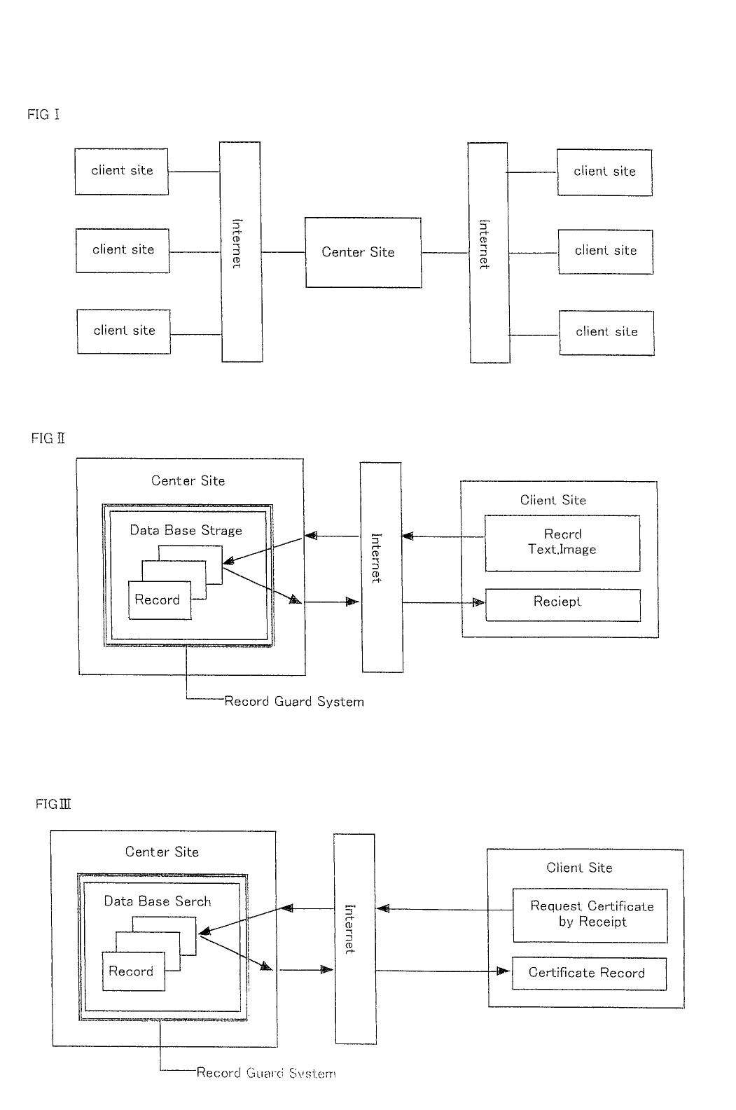

The center site searches on database client's record by his receipt and issue certificate to his record.

We claim:

1. An electronic notarization on net system, comprising:
a center site;
a plurality client sites;
a network connecting the center site and the clients sites to each other;
wherein the center site includes
an open electronic record database for storing therein record from clients' sites, and for a notarization procedure;
Means for accepting records of clients, requested by the clients site to this center site.
Means for storing accepted records.
Means for issuing receipt to the clients for the accepted record.
Means for searching stored records by the issued receipt.
Means for issuing certificate of the acceptance of the record, data with recorded date, when requested by the client with above receipt.
